(19) United States
(12) Patent Application Publication
(10) Pub. No.: US 2009/0280420 A1
(43) Pub. Date: Nov. 12, 2009

(54) ORGANIC PHOTORECEPTOR, IMAGE FORMING METHOD, IMAGE FORMING APPARATUS, AND IMAGE FORMING UNIT

(75) Inventors: Shigeaki TOKUTAKE, Tokyo (JP); Takao FUKAYA, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA BUSINESS TECHNOLOGIES, INC., Tokyo (JP)

(21) Appl. No.: 12/431,796

(22) Filed: Apr. 29, 2009

(30) Foreign Application Priority Data
May 7, 2008 (JP) 2008121027

(51) Int. Cl. G03G 15/04; G03G 13/16; G03G 15/00

(52) U.S. Cl. 430/66; 430/125.3; 399/159

(57) ABSTRACT

An organic photoreceptor comprising a conductive support having thereon at least an intermediate layer and a photosensitive layer, wherein a skewness Rsk of a cross sectional curve of a surface of the conductive support meets the condition of −8<Rsk<0, a method of forming an image and an image forming unit employing the organic photoreceptor, and an image forming apparatus employing the method of forming an image.

This application is based on Japanese Patent Application No. 2008-121027 filed on May 7, 2008 in Japanese Patent Office, the entire content of which is hereby incorporated by reference.

### TECHNICAL FIELD

The present invention relates to an organic photoreceptor, and to an image forming method, an image forming apparatus, and an image forming unit utilizing the organic photoreceptor.

### BACKGROUND

Organic photoreceptors have large advantages such as a wide range of material selection, excellent environmental soundness, and low production cost, compared to inorganic photoreceptors such as selenium-based photoreceptors and amorphous silicon photoreceptors, and have been recently dominant electrophotographic photoreceptors, replacing the inorganic photoreceptors.

On the other hand, in an image forming method based on the Carlson method, charging is carried out on an organic photoreceptor and then an electrostatic latent image is formed thereon to form a toner image. Thereafter, the toner image is transferred on transfer paper and fixed to form the final image.

A corona discharger is most well known as a typical charging member, which has been conventionally used as a member for the above charging means. The corona discharger has the advantage of carrying out stable charging. However, since a relatively high voltage needs to be applied in the corona discharger, large amounts of ionized oxygen, ozone, moisture, and nitrogen oxide compounds are generated. Therefore, problems such as degradation of an organic photoreceptor (hereinafter, also referred to as a photoreceptor) and adverse affects on the human body are produced.

Accordingly, over recent years, there have been conducted investigations to utilize a contact charging method without using a corona discharger. Specifically, a certain voltage is applied to a magnetic brush or a conductive roller serving as a charging member, which then is brought into contact with a photoreceptor as a charged body to charge the surface of the photoreceptor at a specified potential. Use of such a contact charging method makes it possible to realize lower voltage application and a smaller amount of ozone generated, compared to a non-contact charging method using a corona discharger.

The contact charging method is a charge providing method wherein a charging member of a resistance of about 10²-10¹⁰ Ω·cm is applied with a direct current voltage or a direct current voltage superposed with an alternating current voltage and is brought into pressure contact with a photoreceptor. This charging method, based on Paschen's Law, is performed via discharging from a charging member to a charged body. Therefore, charging is initiated by applying a voltage of at least a certain threshold value. This contact charging method makes it possible to lower the applied voltage to the charging member and decrease the amount of ozone and nitrogen oxides generated, compared to the corona charging method.

On the other hand, large progress has been made in digitalization of recent image forming methods. To form an electrostatic latent image on an organic photoreceptor, an image forming method using a laser beam as an exposure source has been largely employed.

However, in a contact charging method with a charging roller, when the support of an organic photoconductor processed to prevent interference fringes (hereinafter, also referred to as moire) by laser beam exposure, namely an aluminum support surface-roughened via surface cut processing is used, there has been produced the problem that dielectric breakdown of projected portions of the cut-processed surface tends to occur via contact charging. Further, when the surface of an organic photoreceptor is repeatedly charged, cracks or contamination is generated in the organic photoreceptor. Thereby, charges are concentrated in the cracked or contaminated portions, resulting in the tendency of occurrence of dielectric breakdown and image defects such as black spots, as well as image unsharpness. Especially under severe conditions such as a high temperature and high humidity condition or a low temperature and low humidity condition, these problems are likely to be produced.

In view of such problems, there is known an organic photoreceptor having a structure wherein an intermediate layer is provided between a conductive support and a photosensitive layer and the intermediate layer contains titanium oxide particles dispersed in a resin. Further, technologies to incorporate surface-treated titanium oxide in the intermediate layer are also known. There are proposed organic photoreceptors having an intermediate layer employing, for example, titanium oxide surface-treated with ferric oxide or tungsten oxide (Patent Document 1); titanium oxide surface-treated with an amino group-containing coupling agent (Patent Document 2); titanium oxide surface-treated with an organic silicon compound (Patent Document 3); titanium oxide surface-treated with methylhydrogenpolysiloxane (Patent Document 4); or dendritic titanium oxide surface-treated with a metal oxide or an organic compound (Patent Document 5).

However, whichever of these technologies is employed, in order to prevent dielectric breakdown or black spots likely to occur via a contact charging method, it is necessary to constitute an intermediate layer, for example, having an adequate film thickness of at least 5 μm. However, when the film thickness of the intermediate layer becomes larger, the residual potential after repeated use increases and then image density tends to decrease. Therefore, it has been difficult to realize compatibility of prevention of occurrence of dielectric breakdown or black spots and sufficient image density.

Patent Document 1: Unexamined Japanese Patent Application Publication (hereinafter, referred to as JP-A) No. 4-303846

Patent Document 2: JP-A No. 9-96916

Patent Document 3: JP-A No. 9-258469

Patent Document 4: JP-A No. 8-328283

Patent Document 5: JP-A No. 11-344826

### SUMMARY OF THE INVENTION

An object of the present invention is to solve the above problems with an organic photoreceptor used for an image forming apparatus based on a contact charging method; and more specifically to solve the above problems with an organic photoreceptor having a conventional intermediate layer containing titanium oxide, to prevent occurrence of dielectric breakdown and image defects such as black spots, and then to provide an organic photoreceptor, an image forming method, an image forming apparatus, and an image forming unit enabling to stably realize an excellent electrophotographic image for a long-term period.

One of the aspects of the present invention to achieve the above object is an organic photoreceptor comprising a conductive support having thereon at least an intermediate layer and a photosensitive layer, wherein a skewness Rsk of a cross sectional curve of a surface of the conductive support meets the condition of −8<Rsk<0.

### BRIEF DESCRIPTION OF THE DRAWINGS

FIG. 1 is a cross-sectional schematic view of an image forming apparatus utilizing a contact charging method according to the present invention

FIG. 2 is across-sectional schematic view of a photoreceptor cartridge detachable to an image forming apparatus

FIG. 3 is a cross-sectional view showing the constitution of a charging roller

FIG. 4 is a cross-sectional view showing one cross-sectional example of a magnetic brush charging unit

FIG. 5 is a view showing one example of a corrugation processed shape having a simple and regular cross sectional curve

FIG. 6 is a view showing one example of a corrugation processed shape having a complex and regular cross sectional curve

FIG. 7 illustrates schematic diagrams for positive and negative skewnesses (Rsk) with respect to a cross sectional curve

FIG. 8 is a schematic illustration of an apparatus for dry ice blasting.

FIG. 9 is an oblique illustration of an apparatus for sand blasting.

### DESCRIPTION OF THE PREFERRED EMBODIMENTS

The above object of the present invention can be achieved by the following structures.
1. An organic photoreceptor comprising a conductive support having thereon at least an intermediate layer and a photosensitive layer, wherein

a skewness Rsk of a cross sectional curve of a surface of the conductive support meets the condition of −8<Rsk<0.
2. The organic photoreceptor of Item 1, wherein

the cross sectional curve has a regular corrugation processed shape.
3. The organic photoreceptor of Item 1 or 2, wherein

the cross sectional curve has a cut processed shape.
4. The organic photoreceptor of any one of Items 1 to 3, wherein

the intermediate layer comprises a N-type semiconductor particle.
5. The organic photoreceptor of Item 4, wherein

the N-type semiconductor particle is a titanium oxide particle or a zinc oxide particle.
6. A method of forming an image comprising the steps of:

charging a surface of an organic photoreceptor;

exposing the charged organic photoreceptor to form an electrostatic latent image;

developing the electrostatic latent image formed on the organic photoreceptor using a toner to form a toner image; and

transferring the toner image formed on the organic photoreceptor onto a transfer medium,

wherein

charging is carried out via a contact charging method; and

the organic photoreceptor is the organic photoreceptor of any one of Items 1 to 5.
7. An image forming apparatus forming an electrophotographic image employing the method of Item 6.
8. An image forming unit having an image forming member, the image forming unit being capable of being loaded into or unloaded from an image forming apparatus, and the image forming unit comprising:

a charging means charging a surface of an organic photoreceptor;

an exposing means exposing the,charged organic photoreceptor to form an electrostatic latent image;

a developing means developing the electrostatic latent image formed on the organic photoreceptor using a toner to form a toner image; and

a transfer means transferring the toner image formed on the organic photoreceptor onto a transfer medium,

wherein

charging is carried out via a contact charging method; and

the organic photoreceptor is the organic photoreceptor of any one of Items 1 to 5.
9. The organic photoreceptor of Item 2, wherein the conductive support is a cylindrical conductive support.
10. The organic photoreceptor of Item 3, wherein the conductive support is a cylindrical conductive support.
11. A method of forming an image comprising the steps of:

charging a surface of an organic photoreceptor;

exposing the charged organic photoreceptor to form an electrostatic latent image;

developing the electrostatic latent image formed on the organic photoreceptor using a toner to form a toner image; and

transferring the toner image formed on the organic photoreceptor onto a transfer medium,

wherein

charging is carried out via a contact charging method, and

the organic photoreceptor is an organic photoreceptor comprising a conductive support having thereon at least an intermediate layer and a photosensitive layer,

wherein
a skewness Rsk of a cross sectional curve of a surface of the conductive support meets the condition of −8<Rsk<0.
12. An image forming unit having an image forming member, the image forming unit being capable of being loaded into or unloaded from an image forming apparatus, and the image forming unit comprising:

a charging means charging a surface of an organic photoreceptor;

an exposing means exposing the charged organic photoreceptor to form an electrostatic latent image;

a developing means developing the electrostatic latent image formed on the organic photoreceptor using a toner to form a toner image; and

a transfer means transferring the toner image formed on the organic photoreceptor onto a transfer medium,

wherein

charging is carried out via a contact charging method; and

the organic photoreceptor is an organic photoreceptor comprising a conductive support having thereon at least an intermediate layer and a photosensitive layer,

wherein
a skewness Rsk of a cross sectional curve of a surface of the conductive support meets the condition of −8<Rsk<0.

The present inventors conducted a series of investigations on the above problems with an organic photoreceptor used for an image forming apparatus based on a contact charging method. Thereby, it was found that in order to prevent black spot occurrence due to leak discharge in the case of using a contact charging method, it was necessary that peak portions in the surface configuration of a surface-processed conductive support should be eliminated to inhibit leak discharge generated from the peak portions. Thus, the present invention was completed.

When an organic photoreceptor of the present invention is used for an image forming apparatus based on a contact charging method, dielectric breakdown and black spots having been conventionally problematic can be prevented and then a high density electrophotographic image can be formed. Further, it is possible to provide an image forming method, an image forming apparatus, and a process cartridge utilizing the above organic photoreceptor.

The present invention will now be detailed.

The organic photoreceptor of the present invention is an organic photoreceptor provided with at least an intermediate layer and a photosensitive layer on a conductive support and then the skewness (Rsk) of a cross sectional curve of the surface of the conductive support meets the condition of −8<Rsk<0.

The organic photoreceptor of the present invention has the structure described above. Thereby, dielectric breakdown and black spots which tend to occur in an image forming apparatus based on a contact charging method can be prevented and then a high density and excellent electrophotographic image can be formed.

The skewness of a cross sectional curve of the surface of a conductive support according to the present invention indicates the degree of distortion (the degree of skew) in a distribution state of mountain portions and valley portions. In the case of Rsk>0, a large number of peaks (mountain portions) are produced in the conductive support surface, whereby a large amount of leak discharge with a contact charging member is generated. Further, in the case of Rsk<−8, interference fringes may be generated, although peaks (mountain portions) in the conductive support surface are decreased and leak discharge between the contact charging member is suppressed.

A cross sectional curve having a regular corrugation processed shape according to the present invention includes all the shapes ranging from regular repetition of a simple corrugated pattern (FIG. 5) to regular repetition of a complex corrugated pattern (FIG. 6).

These regular corrugated patterns can be formed via cut processing. By changing the bite shape for cut processing or by appropriately selecting the indentation angle, the indentation depth, and the number of rotations of the bite, a corrugation pattern ranging from a simple pattern to a complex pattern can be freely carved.

A surface corrugation processed shape showing a regular cross sectional curve included all the patterns ranging from a perfectly regular corrugation pattern to an imperfectly regular corrugation pattern. Namely, even when perfect regularity formed by cut processing is not maintained due to a following treatment such as sand blasting, the imperfect regularity in which only trace of a repeating pattern is remained is included in the scope of a regular corrugation shape according to the present invention.

As the cutting bite, a sintered polycrystalline diamond compact is commonly used in rough processing. And in finish processing, used is a bite composed of single crystal diamond or a sintered polycrystalline diamond compact. With regard to the bite composed of single crystal diamond, either a flat or an R nose shape may be used. In the case of the R shape, those having radium R of the nose roundness of about 10-30 mm are preferably used. With regard to the bite composed of a sintered polycrystalline diamond compact, either a flat or an R nose shape may also be used. However, it is preferable that by using those having a granularity of 0.2 μm-15 μm, polishing is carried out so that the polish finishing roughness of a cutting surface created by a cutting bite is controlled to be 0.3 μm-2.0 μm in terms of maximum roughness Rt. Maximum roughness Rt of the cutting surface created by the cutting bite is determined using surface roughness meter “SURFCOM 1400D” (produced by Tokyo Seimitsu Co., Ltd.). In polishing of a cutting bite, polishing is preferably performed using a diamond wheel mounted on a tool polishing machine.

Further, the minimum value of cutting feed rate v is preferably set at 100 μm/rev or more, and more preferably at 150 μm/rev or more. The maximum value thereof is preferably set at 600 μm/rev or more, and more preferably at 450 μm/rev or more.

It is possible to allow the skewness of a cross sectional curve to fall within the range of the present invention via the following treatment: a conductive support is cutting processed and then treatment such as sandblasting, dry ice blasting, or high pressure water jetting is carried out by appropriately selecting the blasting intensity thereof.

Herein, to realize the skewness of a cross sectional curve of the present invention, it is possible to refer to methods disclosed in JP-A No. 2007-264379 for cut processing; JP-A No. 2005-292565 for a dry ice blasting method; JP-A Nos. 2000-105481 and 2000-155436 for a sandblasting method; and JP-A No. 2006-30580 for a high pressure jetting method.

### <Example of Dry Ice Blasting>

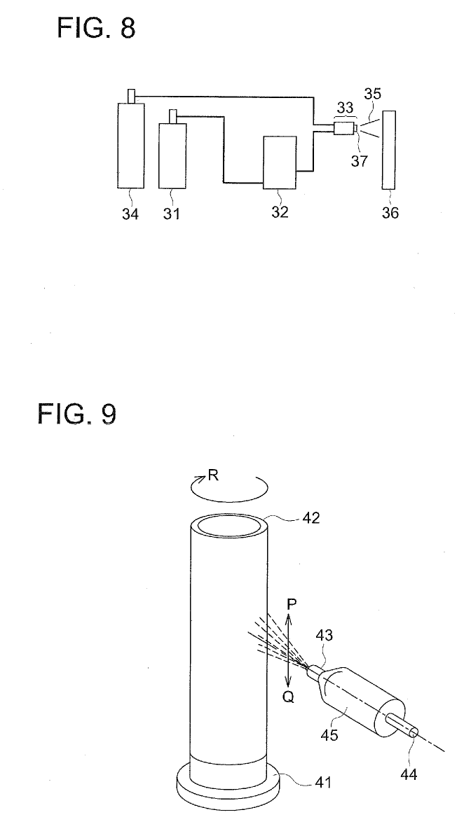

An example of the apparatus for carrying out the blasting process of the production method of a conductive support used by the present invention is shown in FIG. 8. In FIG. 8, 31 represents a liquefied carbon dioxide reservoir (cylinder) by which liquefied carbon dioxide is stored; 32 represents a dry ice particle production means by which liquefied carbon dioxide is cooled and/or expanded to manufacture dry ice particles; 33 represents a dry ice particle squirt means (nozzle) to eject dry ice particles; 37 represents a dry ice ejecting nozzle; 34 represents a compressed gas supply means for providing the compressed gas for giving kinetic energy to dry ice particles to the dry ice particle squirt means 33; 35 represents the dry ice particles ejected from the ejecting nozzle 37 of the dry ice particle squirt means 33; and 36 is a conductive support. The ejection pressure b (MPa) from the ejection nozzle is preferably 1 MPa or less and more preferably 0.8 MPa or less, while it is preferably 0.05 MPa or more and more preferably 0.08 MPa or more. If the ejection pressure b is too large, the conductive support may be damaged (having a dent), while if it is too small, the kinetic energy of dry ice particles may become inadequate, whereby the collision force to the conductive support may become inadequate. The ejection pressure b as mentioned herein represents the internal pressure in the tubing after the dry ice particles are mixed with the compressed gas, which is measured by a manometer.

The distance between the ejecting nozzle of the dry ice squirt means and the surface of the conductive support a (mm) and the abovementioned ejection pressure b preferably meet the condition represented by the following formula (I) and also preferably meet the condition represented by the following formula (II).

a≦−300b²+620b (I)

−6b²+11b≦a (II)

When the distance a does not meet the connection represented by the above formula (I), the kinetic energy of dry ice particles may become inadequate, while, when the distance a does not meet the connection represented by the above formula (II), the consumption efficiency of dry ice particles tends to be lowered.

The angle of a conductive support and a dry ice particle squirt means (nozzle) may be vertical or may be inclined.

Examples of a compressed gas to give kinetic energy to the dry ice particles include: nitrogen gas and carbon dioxide gas which are compressed into high pressure using a compressor. Air compressed into high pressure using a compressor may also be used. In such a case, it is preferable that a filter is used to increase the cleanliness of air.

The supply flow rate of compressed gas is preferably 500 L/min or less and more preferably 300 L/min or less, while it is preferably 5 L/min or more. If the supply flow rate is too large, the dry ice particles tend to be evaporated before dry ice particles collide with the conductive support, whereby the cleaning capacity is lowered, while, when it is too small, the kinetic energy of dry ice particles may become inadequate, whereby the collision force to the conductive support may become inadequate.

When spraying dry ice particles on the surface of the conductive support, in order to make dry ice particles collide with the conductive supporting surface uniformly, it is preferable to carry out while the conductive support is rotated. The peripheral velocity of the rotation of the conductive support is preferably 10-200 m/min and more preferably 30-100 m/min. By rotating the conductive support itself, there obtained an effect of flicking off the extraneous matter which is exfoliated by the collision of dry ice particles. However, when the peripheral velocity of the rotation is too large, the dry ice particles themselves may be licked off.

Further, when the dry ice particles are sprayed onto the surface of the conductive support, it is also preferable to move the dry ice particle squirt means along a direction parallel to the rotation axis of the conductive support in order to make dry ice particles collide with a conductive supporting surface uniformly. The moving rate is preferably 100-5000 mm/min. When the moving rate is too small, the conductive support may be damaged to have a dent since the continuous collision of dry ice particles may occur in the same portion of the conductive support. The spraying of the dry ice particles may be repeated two or more times.

As for installation of the conductive support in the dry ice blast process of the conductive support, any of cross horizontal, vertical and oblique directions may be possible. The dry ice particle squirt means (nozzle) may be single or plural. When using two or more dry ice particle squirt means (nozzle), the distance and angle of each dry ice particle squirt means (nozzle) and the conductive support may be coincided or may be changed.

When installing a dry ice particle squirt means (nozzle) in the state where it is inclined to the conductive support, it is preferable to move the dry ice particle squirt means (nozzle) to the direction opposing the ejection of dry ice particles.

### <Example of Sand Blast Method>

FIG. 9 is an oblique view of a sand blast processing apparatus.

Ejecting nozzle 45 is equipped with ejecting hole 43 and inlet 44 for compressed air and sand. Ejecting nozzle 45 is arranged so that it can move along the direction illustrated by the arrow PQ with keeping a prescribed distance (4-20 cm) from the surface of conductive support 42, while conductive support 42 of which end section is fixed to rotation support unit 41 rotates at prescribed rotational frequency (50-200 rpm) in the direction of rotation shown by the arrow R.

Supplying sand having a particle diameter of 50-100 μm and compressed air from inlet 44, the sand is ejected from ejecting hole 43 onto the outer surface of conductive support 42, while ejecting nozzle 43 is moved at a prescribed speed of 3-20 mm/s. The spray angle against the surface of the conductive support is preferably constant at a prescribed angle of 10°-80°, and the blasting pressure is preferably 1-5 kg/cm². Too large particle diameter of the sand is not preferred since the surface roughness of the conductive support after processed tends to be too large and the Rz value may occasionally become larger than 3.0 μm.

The sand (abradant) used for dry sand blast processing is preferably a powder of, for example, alumina, carborundum, glass or a synthetic resin. Specifically, when an aluminum conductive support is used, alumina is preferably used. When the particle diameter of an abradant is too large, besides the tendency to the too large corrugation on the blast processed surface, there may be a disadvantage that a coarse abradant particle may stick onto the conductive support surface to cause a projecting defect on the surface, which may also cause black or white spot defect on the image.

### <Example of a High-Pressure Jet Method>

A conductive support drum is arranged with the axes of the drum being disposed in a vertical direction. A support frame is fitted to the support drum to prevent the drum from falling when subjected to the high pressure cleaning liquid. The support frame preferably has a shape that will not damage the conductive support and not obstruct the cleaning.

The position of the high pressure nozzle above the conductive support is determined by the following formula (III), where Φ is a diameter of the support drum, θ is a spread angle of the cleaning liquid ejected from the high pressure cleaning nozzle, and h is a distance between the top of the support drum and the nozzle hole.

h≧Φ/(2 tan(θ/2)) (III)

For example, provided that a spread angle θ is 25 degrees and a support drum diameter Φ is 30 mm, the distance h between the top of the support drum and the nozzle hole (i.e., the height of the high-pressure nozzle) is calculated to be about 67.7 mm. The height of the high pressure nozzle is thus preferably at least 67.7 mm and should be a similar height. This height is effective for a support drum having a length between 240 mm to 370 mm. The cleaning effect does not vary along a longitudinal direction of the support drum having this range of length, so that the drum support is cleaned uniformly from its top to its bottom.

The ejection of the high pressure cleaning liquid is conducted by a high pressure jet apparatus using a high pressure plunger pump manufactured by Maruyama Excell Co., Ltd. The cleaning liquid is pressurized by the high pressure plunger pump and ejected from the high pressure nozzle towards the support drum. The high pressure nozzle is connected to the plunger pump through a piping. The cleaning liquid is pure water or an alkaline cleaning liquid at a liquid temperature of 50° C., or an alkaline electrolytic solution at a hydrogen ion exponent (pH) of 11.5. The cleaning liquid is ejected at a liquid flow rate of 3-15 L/min in a direction approximately perpendicular to the traversing direction of the nozzle, and with a spread angle θ of 10-45 degrees. The high pressure nozzle is horizontally moved at a velocity of 1-10 mm/s. The alkaline electrolytic solution is a cleaning liquid obtained by electrolysis of a potassium carbonate solution.

The skewness (Rsk) of the cross sectional curve according to the present invention conforms to the definition of JIS B 0601:2001 which corresponds to ISO 4287-1997 and is represented by the following expression:

$$Rsk = \frac{1}{{Rq}^{3}} ( \frac{1}{{I}_{r}} {\int }_{o}^{{I}_{r}} {Z}^{3} ( x ) d x )$$

Rq: root-mean-square roughness

Ir: length in the x axis direction

Z(x): height in the Z axis direction at position x

Further, the skewness (Rsk) of a cross sectional curve according to the present invention is determined under the following measurement conditions.

### Measurement Conditions

Measurement instrument: surface roughness meter (SURFCOM 1400D, produced by Tokyo Seimitsu Co., Ltd.)

Measurement length L: 8.0 mm

Cut-off wavelength λc: 0.08 mm

Stylus tip shape: 60° tip angle cone

Stylus tip radius: 0.5 μm

Measurement rate: 0.3 mm/second

Measurement magnification: 100000 times

Measurement locations: 3 locations (in the case of a cylindrical conductive support, 3 locations of (i) the middle point of a line drawn parallel to the rotation axis of the cylindrical conductive support on the surface of the cylindrical conductive support (hereafter designated as line A), and (ii) the middle points of two line segments, each line segment being drawn between the above mentioned middle point of line A and one of the two end points of line A)

The average value for the above 3 locations is designated as the skewness (Rsk) of the present invention.

When the conductive support is a cylindrical conductive support, the above X axis direction may be a direction of abovementioned line A.

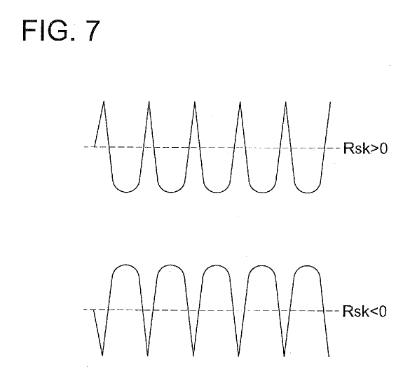

Next, schematic diagrams will be exemplified in FIG. 7 for positive and negative skewnesses (Rsk) with respect to a cross sectional curve.

As a conductive support used for the photoreceptor of the present invention, either a sheet or cylindrical conductive support may be used. However, the cylindrical conductive support is preferable.

The cylindrical conductive support of the present invention refers to a cylindrical support which enables to form images in an endless manner via rotation of the cylindrical support. Preferable is a conductive support exhibiting a straightness of at most 0.1 mm and a deflection of at most 0.1 mm. When the straightness or the deflection exceed the above range, excellent image formation becomes difficult to realize.

As a cylindrical support used for the photoreceptor of the present invention, those having a diameter of 10-300 mm are preferable. However, in order to obtain notable effects of the present invention and improve adhesion of the support to the intermediate layer, and simultaneously to obtain the effect of preventing occurrence of black spots, a photoreceptor of a small-diameter cylindrical conductive support having a diameter of 10-50 mm is preferably used.

As a conductive material, there can be used a metal drum of such as aluminum or nickel, a plastic drum deposited with aluminum, tin oxide, or indium oxide, or a paper or plastic drum coated with a conductive substance. The conductive support preferably has a specific resistance of at most 10³ Ωcm at normal temperature.

On the surface of a conductive support used in the present invention, an alumite layer having been subjected to sealing treatment may beprovided. Alumite treatment is commonly carried out in an acid bath such as chromic acid, sulfuric acid, oxalic acid, phosphoric acid, boric acid, or sulfamic acid. Of these, anodization treatment in sulfuric acid gives the most preferable result. The anodization treatment in sulfuric acid is preferably carried out at a sulfuric acid concentration of 100-200 g/l, an aluminum ion concentration of 1-10 g/l, a liquid temperature of about 20° C., and an applied voltage of about 20 V. However, these conditions are not limited. Further, the average film thickness of an anodized coated film is commonly at most 20 μm, specifically preferably at most 10 μm.

The constitution of a specific photoreceptor preferably used in the present invention will now be described.

### Conductive Support

As a conductive support according to the present invention, a conductive support having the above-described characteristics is used.

Further, the conductive support of the present invention is preferably produced at a surface roughness of 0.5-2.5 μm based on ten-point average roughness Rz. The above skewness of a cross sectional curve is constituted within the range of the present invention on a conductive support having been processed at such a surface roughness, and then thereon, an intermediate layer containing an N-type semiconductive particle to be described later is arranged. Thereby, occurrence of moire can efficiently be prevented even in the case of using interfering light such as a laser beam without occurrence of dielectric breakdown or black spots.

Definition and Determination Method of Surface Roughness Rz (Ten-Point Average Roughness)

Rz described above refers to “ten-point average roughness” set forth in JIS B0601-1982, namely, being the difference between the average height of 5 peaks from the highest one and the average depth of 5 valleys from the deepest one in a standard distance of the reference length.

Measurement Conditions

Measurement instrument: surface roughness meter (SURFCOM 1400D, produced by Tokyo Seimitsu Co., Ltd.)
Measurement length L: standard value of the reference length
Stylus tip shape: 60° tip angle cone
Stylus tip radius: 0.5 μm
Measurement rate: 0.3 mm/second
Measurement magnification: 100000 times
Measurement locations: 3 locations being an upper, a middle, and a lower one (in the case of a cylindrical support, 3 locations at the middle point between the center and the end portion of the axis)

The average value of Rz's of the above 3 locations is designated as an Rz value.

In the present invention, the above intermediate layer having a barrier function is arranged between a conductive support and a photosensitive layer.

The intermediate layer of the present invention needs to be coated and dried at a dry film thickness of 0.2-15 μm. The dry film thickness is preferably 0.3-10 μm, more preferably 0.5-8 μm.

An N-type semiconductive particle used in the present invention refers to a fine particle having a nature wherein its conductive carriers are electrons. Namely, the nature wherein the conductive carriers are electrons refers to one wherein by incorporating an N-type semiconductive particle in an insulating binder, hole injection from the support is efficiently blocked; and in contrast, no blocking properties against electrons from a photosensitive layer are expressed.

The N-type semiconductive particle includes fine particles, specifically, such as titanium oxide (TiO₂), zinc oxide (ZnO), or tin oxide (SnO₂). Of these, in the present invention, titanium oxide is specifically preferably used.

The average particle diameter of an N-type semiconductive particle used in the present invention is preferably 10-200 nm, more preferably 15-150 nm in terms of number average primary particle diameter. An intermediate layer coating liquid, utilizing an N-type semiconductive particle having a number average primary particle diameter in the above range, exhibits excellent dispersion stability. Further, an intermediate layer formed from such a coating liquid functions to prevent occurrence of black spots and exhibits favorable environmental characteristics and cracking resistance.

The number average primary particle diameter of the N-type semiconductive particle is a measurement value obtained as follows: for example, in the case of titanium oxide, randomly selected 100 particles are observed as primary particles via transmission electron microscope observation at a magnification of 10000, and then the measurement value is calculated as a Fere direction average diameter via image analysis.

Shapes of N-type semiconductive particles used in the present invention include shapes such as a dendritic, a needle, and a granular one. With regard to N-type semiconductive particles of such shapes, for example, in titanium oxide particles, there are an anatase type, a rutile type, and an amorphous type as crystal types. Those having any of these crystal types may be used, and at least 2 kinds of the crystal types may be used in combination. Of these, rutile type particles are most preferable.

One of the surface treatments for the N-type semiconductive particle of the present invention is carried out in such a manner that surface treatments of multiple times are conducted, and of the surface treatments of multiple times, the final surface treatment is a surface treatment using a reactive organic silicon compound. Further, of the surface treatments of multiple times, it is preferable that at least one of the surface treatments be a surface treatment using at least one selected from alumina, silica, and zirconia, and then a surface treatment using a reactive organic silicon compound be conducted last.

Herein, alumina treatment, silica treatment, or zirconia treatment refers to treatment to allow alumina, silica, or zirconia to be precipitated on the surface of N-type semiconductive particles. Such alumina, silica, or zirconia precipitated on the surface includes a hydrate of alumina, silica, or zirconia. Further, the surface treatment with a reactive organic silicon compound refers to use of the reactive organic silicon compound for a treatment solution.

In such a manner, by conducting surface treatment of N-type semiconductive particles such as titanium oxide particles at least twice, the surface of the N-type semiconductive particles is uniformly subjected to surface covering (treatment). Therefore, when the surface treated N-type semiconductive particles are used in an intermediate layer, there can be obtained an excellent photoreceptor exhibiting enhanced dispersibility with respect to N-type semiconductive particles such as titanium oxide particles in the intermediate layer, as well as causing no image defects such as black spots.

Further, it is specifically preferable to carry out, as the surface treatments of multiple times, surface treatment using alumina and silica and then surface treatment using a reactive organic silicon compound.

Herein, the above alumina treatment and silica treatment may be carried out simultaneously. It is specifically preferable to conduct the alumina treatment initially and then the silica treatment. Further, when treatment is carried out using alumina and silica individually, the treatment amount of silica is preferably larger than that of alumina.

The surface treatment of N-type semiconductive particles such as titanium oxide using metal oxides such as alumina, silica, and zirconia is carried out via a wet method. For example, N-type semiconductive particles surface-treated with silica or alumina can be produced as described below.

When titanium oxide particles are used as N-type semiconductive particles, titanium oxide particles (number average primary particle diameter: 50 nm) are dispersed in water at a concentration of 50-350 g/l to form an aqueous slurry and then a water-soluble silicate or a water-soluble aluminum compound is added to the slurry. Then, neutralization is performed via addition of an alkali or an acid to allow silica or alumina to be precipitated oh the surface of the titanium oxide particles. Subsequently, filtration, washing, and drying are carried out to obtain the targeted surface-treated titanium oxide. When sodium silicate is used as the above water-soluble silicate, neutralization can be performed using an acid such as sulfuric acid, nitric acid, or hydrochloric acid. On the other hand, when aluminum sulfate is used as the water-soluble aluminum compound, neutralization can be conducted using an alkali such as sodium hydroxide or potassium hydroxide.

Herein, the amount of a metal oxide used for the above treatment is preferably 0.1-50 parts by mass, more preferably 1-10 parts by mass as the amount fed during the above surface treatment, based on 100 parts by mass of N-type semiconductive particles such as titanium oxide particles. Incidentally, also in the case of using alumina and silica as described above, for example, with regard to titanium oxide particles, an amount of 1-10 parts by mass each is preferably used based on 100 parts by mass of the titanium oxide particles, and the amount of the silica is preferably larger than that of the alumina.

Surface treatment using a reactive organic silicon compound preceded by the surface treatment with a metal oxide is preferably carried out via a wet method as described below.

Namely, titanium oxide treated with the above metal oxide is added in a liquid prepared by dissolving or suspending the above reactive organic silicon compound in an organic solvent or water, and then the resulting liquid is stirred for several minutes to about 1 hour. Then if necessary, the liquid is heated. Thereafter, drying is carried out, after a process such as filtration, to obtain titanium oxide particles whose surface has been covered with the organic silicon compound. Herein, the reactive organic silicon compound may be added in a suspension prepared by dispersing titanium oxide in an organic solvent or water.

Incidentally, combinations of surface analysis methods such as photoelectron spectrometry (ESCA), Auger electron spectroscopy (Auger), secondary ion mass spectrometry (SIMS), and diffuse reflection FI-IR make it possible to confirm whether in the present invention, the titanium oxide particle surface is covered with a reactive organic silicon compound.

The amount of a reactive organic silicon compound used for the above surface treatment is preferably 0.1-50 parts by mass, more preferably 1-10 parts by mass as the amount fed during the surface treatment, based on 100 parts by mass of titanium oxide treated with the metal oxide.

Examples of a reactive organic silicon compound used in the present invention include a compound represented by following Formula (2). However, any compound which undergoes condensation reaction with a reactive group such as a hydroxyl group on the surface of titanium oxide is not limited by the following compound.

(R)ₙ—Si—(X)₄₋ₙ Formula (2)

wherein Si represents a silicon atom; R represents an organic group with a carbon atom directly joining the silicon atom; X represents a hydrolyzable group; and n represents an integer of 0-3.

In organic silicon compounds represented by Formula (2), as the organic group with a carbon atom directly joining the silicon atom represented by R, there are listed an alkyl group such as a methyl, ethyl, propyl, butyl, pentyl, hexyl, octyl, or dodecyl group; an aryl group such as a phenyl, tolyl, naphthyl, or biphenyl group; an epoxy-containing group such as a γ-glycidoxypropyl or β-(3,4-epoxycyclohexyl)ethyl group; a (meth)acryloyl-containing group such as a γ-acryloxypropyl or γ-methacryloxypropy group, a hydroxy-containing group such as a γ-hydroxypropyl or 2,3-dihydroxypropyloxypropyl group; a vinyl-containing group such as a vinyl or propenyl group; a mercapto-containing group such as a γ-mercaptopropyl group; an amino-containing group such as a γ-aminopropyl or N-β(aminoethyl)-γ-aminopropyl group; a halogen-containing group such as a γ-chloropropyl, 1,1,1-trifluoropropyl, nonafluorohexyl, or perfluorooctylethyl group; and a nitro- or cyano-substituted alkyl group. Further, examples of the hydrolyzable group of X include an alkoxy group such as a methoxy or ethoxy group, a halogen group, and an acyloxy group.

Further, the organic silicon compounds represented by Formula (2) may be used individually or in combination of at least 2 types.

Still further, in specific compounds of the organic silicon compounds represented by Formula (2), when n is at least 2, a plurality of R's may be the same or differ. Similarly, when n is at most 2, a plurality of X's may be the same or differ. And, when at least 2 types of the organic silicon compounds represented by Formula (2) are used, R's and X's each may be the same or differ among these compounds.

Yet further, as the organic silicon compounds represented by Formula (2), organic silicon compounds represented by following Formula (1) are preferably used.

R—Si—X₃ Formula (1)

wherein R represents an alkyl or aryl group, and X represents a methoxy, ethoxy, halogen group.

As the organic silicon compounds represented by Formula (1), organic silicon compounds, having an alkyl group with a carbon number of 4-8 as R, are preferable. Specific examples of such preferable compounds include trimethoxy-n-butylsilane, trimethoxy-i-butylsilane, trimethoxyhexylsilane, and trimethoxyoctylsilane.

Further, as reactive organic silicon compounds preferably used for the final treatment, polysiloxane compounds are cited. With regard to these polysiloxane compounds, those having a molecular weight of 1000-20000 are commonly easily obtainable, exhibiting an excellent function to prevent occurrence of black spots.

Especially, use of methylhydrogenpolysiloxane for the final surface treatment can produce excellent effects.

Another surface treatment of titanium oxide of the present invention relates to titanium oxide particles surface-treated with an organic silicon compound having a fluorine atom. The surface treatment with the fluorine atom-containing organic silicon compound is preferably conducted via the wet method described above.

Namely, the above fluorine atom-containing organic silicon compound is dissolved or suspended in an organic solvent or water, and then untreated titanium oxide is added therein. Such a resulting solution is mixed by stirring for several minutes to about 1 hour. Then if necessary, the solution is heated. Thereafter, drying is carried out, after a process such as filtration, to cover the titanium oxide surface with the fluorine atom-containing organic silicon compound. Herein, the fluorine atom-containing organic silicon compound may be added in a suspension prepared by dispersing titanium oxide in an organic solvent or water.

Incidentally, combinations of surface analysis methods such as photoelectron spectrometry (ESCA), Auger electron spectroscopy (Auger), secondary ion mass spectrometry (SIMS), and diffuse reflection FI-IR make it possible to confirm whether the titanium oxide surface is covered with a fluorine atom-containing organic silicon compound.

Fluorine atom-containing organic silicon compounds used in the present invention include 3,3,4,4,5,5,6,6,-nonafluorohexyltrichlorosilane, 3,3,3,-trifluoropropyltrimethoxysilane, methyl-3,3,3-trifluoropropyldichlorosilane, dimethoxymethyl-3,3,3-trifluoropropylsilane, and 3,3,4,4,5,5,6,6,6-nonafluorohexylmethyldichlorosilane.

Next, description will now be made with respect to the constitution of an intermediate layer utilizing N-type semiconductive particles such as titanium oxide particles surface-treated as described above (hereinafter, also referred to as surface-treated N-type semiconductive particles; and further specifically, titanium oxide particles surface-treated are also referred to as surface-treated titanium oxide).

The intermediate layer of the present invention is produced by coating, on a conductive support, a liquid prepared by dispersing, together with a binder resin, surface-treated N-type semiconductive particles such as surface-treated titanium oxide obtained via the above surface treatments of multiple times in a solvent.

The intermediate layer of the present invention is arranged between a conductive support and a photosensitive layer, and functions to improve adhesion between the conductive support and the photosensitive layer, as well as exhibiting a barrier function to prevent charge injection from the support. Examples of binder resins for the intermediate layer include polyamide resins, vinyl chloride resins, vinyl acetate resins, polyvinyl acetal resins, polyvinyl butyral resins, polyvinyl alcohol resins, and thermosetting resins such as melamine resins, epoxy resins, or alkyd resins, as well as copolymer resins containing at least 2 kinds of the repeating units of these resins. Of these binder resins, polyamide resins are specifically preferable. Alcohol-soluble polyamides via copolymerization or methoxymethylol treatment are most preferable.

The amount of the surface-treated N-type semiconductive particle of the present invention dispersed in any of the above binder resins, for example, in the case of surface-treated titanium oxide, is 10-10,000 parts by mass, preferably 50-1,000 parts by mass, based on 100 parts by mass of the binder resin. When the surface-treated titanium oxide is used within this range, dispersibility of the titanium oxide can favorably be maintained, whereby an excellent intermediate layer free from occurrence of black spots can be formed.

Further, the intermediate layer of the present invention is substantially an insulating layer. Herein, the insulating layer features a volume resistance of 1×10⁸-10¹⁵ Ω·cm. The volume resistance of the intermediate layer of the present invention is preferably 1×10⁹-10¹⁴ Ω·cm, more preferably 2×10⁹-1×10¹³ Ω·cm. The volume resistance can be determined as follows.

Measurement conditions: based on JIS C2318-1975

Measurement instrument: HIRESTA IP (produced by Mitsubishi Petrochemical Co., Ltd.)

Measurement condition: measurement probe HRS

Applied voltage: 500 V

Measurement ambience: 20±2° C. and 65±5 RH %

The surface roughness of the intermediate layer of the present invention is preferably 0.20-3.00 μm, more preferably 0.20-2.00 μm in terms of Rmax.

An intermediate layer coating liquid produced to form the intermediate layer of the present invention incorporates a surface-treated N-type semiconductive particle such as the above surface-treated titanium oxide, a binder resin, and a dispersion solvent. As the dispersion solvent, those similar to solvents used to produce another layer such as a photosensitive layer are appropriately used.

Namely, examples of solvents or dispersion media used to form the intermediate layer, the photosensitive layer, and other resin layers of the present invention include n-butylamine, diethylamine, ethylenediamine, isopropanolamine, triethanolamine, triethylene diamine, N,N-dimethylformamide, acetone, methyl ethyl ketone, methyl isopropyl ketone, cyclohexanone, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofuran, dioxolan, dioxane, methanol, ethanol, butanol, isopropanol, ethyl acetate, butyl acetate, dimethylsulfoxide, and methyl cellosolve.

The intermediate layer coating liquid solvent is not limited thereto, but methanol, ethanol, butanol, 1-propanol, and isopropanol are preferably used. Further, these solvents can also be used individually or as a mixed solvent of at least 2 kinds thereof.

Further, to prevent occurrence of drying non-uniformity during intermediate layer coating, as the intermediate layer coating solvent, a mixed solvent of methanol and a straight-chain alcohol exhibiting high resin solubility is preferably used. A preferable solvent ratio is a mixture ratio of 0.05-0.6 of a straight-chain alcohol to 1 of methanol in terms of volume ratio. When the coating solvent is prepared as a mixed solvent in this manner, its solvent evaporation rate is appropriately maintained and occurrence of image defects due to drying non-uniformity during coating can be prevented.

As a dispersion method of surface-treated titanium oxide used to produce an intermediate layer coating liquid, any dispersion method of a sand mill, a ball mill, and an ultrasonic dispersion method is usable.

As a coating process method to produce the electrophotographic photoreceptor of the present invention, as well as the above intermediate layer, a coating process method such as immersion coating, spray coating, or circular amount regulation type coating is used. In coating processing on the upper layer side of a photosensitive layer, in order for the film of the lower layer to be dissolved as little as possible and also to realize uniform coating processing, it is preferable to use a coating process method such as spray coating or circular amount regulation type (a typical example thereof is a circular slide hopper type) coating. Herein, the above spray coating is detailed, for example, in JP-A Nos. 3-90250 and 3-269238, and the above circular amount regulation type coating is detailed, for example, in JP-A No. 58-189061.

### Photosensitive Layer

The photosensitive layer of the photoreceptor of the present invention may be one having a single layer structure exhibiting charge generation and charge transport functions formed on the abovementioned intermediate layer, but is preferably one having a separate layer structure in which charge generating layer (CGL) and charge transport layer (CTL) each exhibit a separated function of the photosensitive layer. Increase in residual potential via repetitive use can be controlled to be minimized by taking the separate function layer structure, whereby other electrophotographic properties can be easy controlled according to the purpose. In the case of a photoreceptor for negative electrification, charge generation layer (CGL) is preferably provided on an intermediate layer, and charge transport layer (CTL) is provided thereon. In the case of a photoreceptor for positive electrification, the charge generation layer and the charge transport layer are arranged to be reversely placed. The preferable layer structure of the photoreceptor is of the case where a photoreceptor for negative electrification has the foregoing separate function layer structure.

The photosensitive layer constitution employed for a photoreceptor for negative electrification having the separate function layer structure will be described below.

### Charge Generating Layer

A charge generation layer contains a charge generation material (CGM). A binder resin and additives as other materials may optionally be contained in the charge generation layer.

As CGM, well known charge generation materials are applicable. For example, a phthalocyanine pigment, an azo pigment, a perylene pigment and an azulenium pigment are usable. Of these, a CGM which enables to minimized the residual potential after repeated use is one which has a steric structure and an electronic structure providing a stable agglomeration structure among a plurality of molecules, specific examples of which include CGMs such as a phthalocyanine pigment having a specified crystal structure and a perylene pigment. For example, CGMs such as titanyl phthalocyanine having a maximum peak at a Bragg angle (2θ±0.2°) of 27.2° in a CuKα X-ray diffraction spectrum and benzimidazole perylene having a maximum peak at 2θ of 12.4° exhibit only limited deterioration after repeated use and enable to minimized the residual potential.

When a binder is used as a dispersing medium for CGM in a charge generating layer, commonly known binders are usable, but examples of most preferable resins include a formal resin, a butyral resin, a silicone resin, a silicone-modified butyral resin and a phenoxy resin. A ratio of CGM to the hinder resin is preferably 20-600 parts by mass of CGM per 100 parts by mass of the binder resin. The increase in residual potential after repeated use can be minimized by using such a resin. The charge generating layer preferably has a layer thickness of 0.01-2.00 μm.

### Charge Transport Layer

A charge transport layer contains a charge transport material (CTM) and a binder resin which is used to disperse the CTM and to form a film. As other material, an additive such as an antioxidant may be contained if necessary.

As a charge transport material (CTM), commonly known CTM is usable, and examples thereof include a triphenylamine derivative, a hydrazone compound, a styryl compound, a benzidine compound and a butadiene compound. Such a charge transport material is usually dissolved in an appropriate binder resin to form a layer. Among the above charge transport materials, the CTM which enables to minimize residual potential after repeated use is one exhibiting a high charge mobility and exhibiting a difference in ionization potential of 0.5 eV or less compared to the ionization potential of CGM used in combination. The difference in the ionization potentials is preferably 0.25 eV or less.

The ionization potentials of CGM and CTM are determined by using a surface analyzer AC-1 produced by RIKEN KEIKI Co., Ltd.

Examples of the resin employed for CTL include polystyrene, an acrylic resin, a methacrylic resin, a vinylchloride resin, a vinyl acetate resin, a polyvinyl butyral resin, an epoxy resin, a polyurethane resin, a phenol resin, a polyester resin, an alkyd resin, a polycarbonate resin, a silicone resin, a melamine resin and a copolymer resin containing at least two repeating units of the above-described resins. Other than these insulating resins, an organic polymer semiconductor such as poly-N-vinylcarbazole and is applicable.

Of these CTL binders, a polycarbonate resin is most preferable as a binder for CTL. The polycarbonate resin is most preferable in view of excellent dispersibility of CTM and an excellent electrophotographic property. The ratio of the charge transport material to the binder is preferably 10-200 parts by mass of CTM per 100 parts by mass of the binder resin. In addition, the charge transport layer preferably has a layer thickness of 10-40 μm.

### Surface Layer

By providing the abovementioned siloxane layer relating the present invention as a surface layer of the organic photoreceptor, an organic photoreceptor having a most preferable layer constitution of the present invention can be obtained.

Although an example of a most preferable layer constitution of the present invention is described above, the layer constitution of a photoreceptor other than the abovementioned constitution is also applicable.

Next, an image forming apparatus and an image forming method employing the organic photoreceptor of the present invention will be explained.

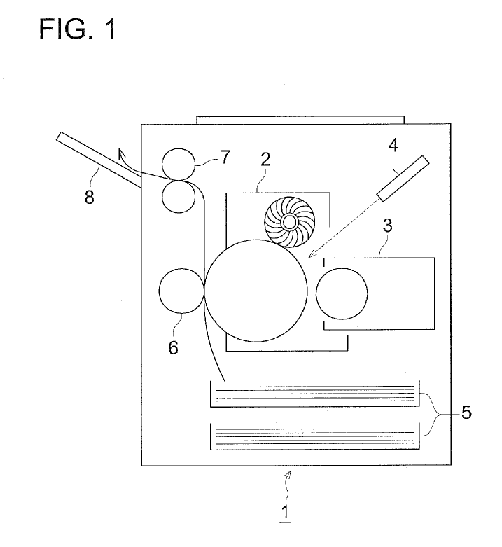

FIG. 1 is a schematic cross-sectional view of image forming apparatus 1 employing a contact electrification system of the present invention. Image forming apparatus 1 has therein photoreceptor cartridge 2, developing cartridge 3, exposure device 4 that emits a laser beam modulated based on image signals coming from the outside, while deflecting the laser beam, sheet feeding device 5 that feeds a recording sheet, transfer roller 6, fixing device 7 and sheet ejection tray 8.

Photoreceptor cartridge 2 is provided therein with photoreceptor 21 that is made by forming a thin film layer of organic photoconductive material on an outer circumferential surface of a cylindrical body, and with charging brush 22. Developing cartridge 3 is provided therein with an unillustrated developing sleeve, a stirring roller, and with a toner tank in which toner and carrier are housed, and developing bias is impressed on the developing sleeve from an unillustrated developing power supply. For preventing generation of troubles caused by mechanical contact in the case of mounting cartridges on or removing them from image forming apparatus 1, each of both cartridges is provided with an unillustrated protective cover that is closed in the case of insertion into image forming apparatus 1 and is opened in the case of removing from image forming apparatus 1.

Since the image forming process is widely known, it will be shown simply as follows. First, a surface of photoreceptor 21 is charged evenly with prescribed voltage by charging brush 22. Exposure unit 4 generates modulated laser beam (that is shown with an arrow of a broken line), then, this laser beam is deflected by an unillustrated polygon mirror for deflection scanning on photoreceptor 21, thus, electrostatic latent images corresponding to image information are formed on the charged surface in succession.

In the method of forming an image according to the present invention, it is preferable that a dot latent image is formed using a semiconductor laser or an emitting diode as an imagewise exposure light source, when an electrostatic latent image is formed on a photoreceptor. By conducting digital exposure on an organic photoreceptor using such an imagewise exposure light source, while decreasing a spot diameter of imagewise exposure (representing the spot diameter of the exposure beam) 80 nm or less, preferably 60 nm or less, and further preferably 15 nm or less, a high resolution electrophotographic image of 400 dpi-2400 dpi (dpi representing number of dots per 2.54 cm) can be obtained.

The above spot diameter represents a diameter of a circle of which area corresponds to the area of the spot having an intensity of light higher than 1/e² of the peak intensity of the exposure beam.

Toner housed in a toner tank is supplied onto the developing sleeve after being stirred by the stirring roller, and forms a toner image corresponding to the electrostatic latent image at a portion facing photoreceptor 21. Simultaneously, residual toner remaining on the unexposed portion (non-image portion) on the surface of photoreceptor 21 is collected in the developing cartridge, by using the voltage difference between developing bias voltage to be impressed on the developing sleeve and surface voltage of the photoreceptor 21. On the other hand, a toner image is electrostatically transferred onto a recording sheet by transfer roller 6 arranged to face the photoreceptor 21. Incidentally, a recording sheet is brought from sheet feeding device 5 along a conveyance path shown with an arrow of solid line in the drawing. Then, this recording sheet is conveyed to fixing device 7 where unfixed toner image is fixed on the recording sheet through heat fixing. Finally, the recording sheet on which aimed images are formed is ejected to sheet ejection tray 8. Thus, many duplicates of a document can be made at high speed, by repeating the aforementioned series of process.

The charging brush stirs mechanically residual toner conveyed by rotation of the photoreceptor to the contact portion between the photoreceptor and the charging brush, and diffuses it on the surface of the photoreceptor until the moment when the residual toner becomes unreadable. Further, the charging brush absorbs residual toner having polarity opposite to that of electrification polarity of the photoreceptor (reverse polarity) on an electrostatic basis, to collect it, and charges it to be of the same polarity (regular polarity) as the electrification polarity of the photoreceptor to discharge on the photoreceptor surface.

The recovery of the residual toner remained on the organic photoreceptor is finally carried out in the developing sleeve. In this process, the organic photoreceptor after transferring the toner image returns to the charging means without being in touch with a cleaning means. Namely, image forming apparatus 1 adopts a cleanerless method (a cleanerless process). However, a cleaning means may be used, if necessary.

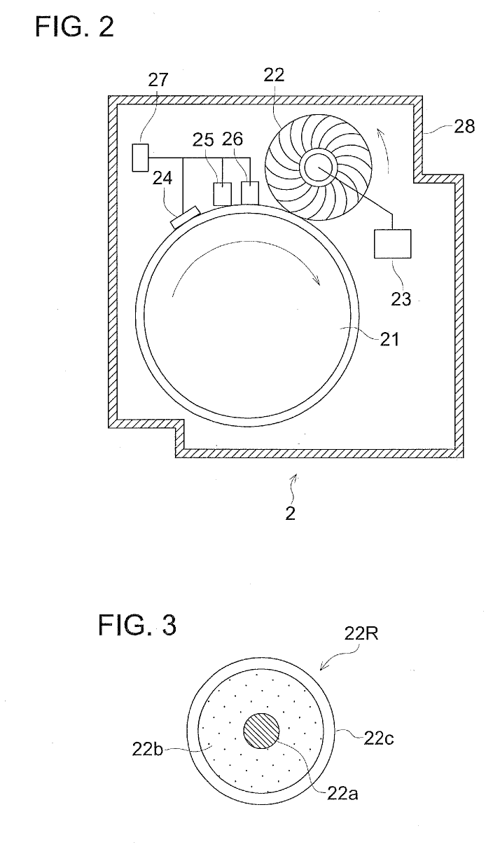

FIG. 2 is a schematic cross-sectional view of photoreceptor cartridge 2 capable of freely mounting on or removing from image forming apparatus 1. In casing 28 with a protective cover of photoreceptor cartridge 2, there are provided photoreceptor 21 representing an image carrier, charging brush 22 arranged around photoconductor 21 to be in contact therewith, power supply connection member 23 for impressing prescribed voltage on charging brush 22, pre-charging film 24, charging shakedown members (sponge-shaped charging members) 25 and 26 and power supply connection member 27.

Photoconductor 21 is rotated by an unillustrated driving apparatus in the direction of an arrow in the drawing. Charging brush 22 is one wherein conductive bristles composed of capillary fibers are flocked on a brush support. This charging brush 22 is rotated by an unillustrated driving device in the direction of an arrow in the drawing, under the condition that the charging brush is in contact with the surface of photoreceptor 21, namely, it is rotated in the same direction as that of photoreceptor 21 in the portion of contact between photoreceptor 21 and charging brush 22. In the course of image forming, voltage is applied onto charging brush 22 by an unillustrated power supply, whereby, the surface of photoreceptor 21 is charged evenly to be in the prescribed polarity. On the other hand, in the course of non-image forming, voltage having polarity that is opposite to that in the image forming is applied onto charging brush 22 by a power supply for charging. Incidentally, charged polarity of toner is the same as polarity of charging voltage in the image forming. Therefore, toner accumulated in charging brush 22 in the course of non-image forming can be discharged on photoreceptor 21 by electrostatic repelling power.

Development-pre-charging film 24 and charging shakedown members 25 and 26 are arranged to make up for charging unevenness caused by charging brush 22.

In the image forming apparatus according to the present invention, a polymerized toner is preferably used in the developer used in the above developing means. By using a polymerized toner exhibiting homogeneous shape and particle diameter in combination with the organic photoreceptor of the present invention, an electrphotographic image having excellent sharpness can be obtained.

The polymerized toner is a toner in which formation of the binder resin and making the shape of the toner are performed by polymerization of a raw material monomer, and a chemical treatment after the polymerization if necessity. In concrete, the toner is formed by a polymerization reaction such as suspension polymerization and emulsion polymerization and, if necessary, by a process for fusing the particles carried out after the polymerization.

Since the polymerized toner is manufactured via a polymerization carried out after a raw material monomer is homogeneously dispersed in an aqueous medium, a toner exhibiting homogeneous shape and particle diameter can be obtained.

A polymerized toner can be manufactured by forming minute polymerized particles by a suspension polymerization method or by emulsion-polymerizing a monomer in a liquid in which emulsion liquid of a necessary additive, followed by associating the particles after adding an organic solvent or a flocculant. Further, the abovementioned toner can also be manufactured by employing the method of mixing and associating, for example, a releasing agent and a coloring agent which are necessary constituents of the toner with the particles, in the association process, or by employing the method of dispersing constituents of the toner, for example, a releasing agent and a coloring agent together with the polymerizable monomer, followed by emulsion-polymerizing. The term of “association” means that a plurality of resin particles and a plurality of coloring agent particles fuse with each other.

Namely, a toner can be manufactured, for example, as follows: adding various kinds of constituents, such as a colorant, a releasing agent, a charge controlling agent and a polymerizing initiation agent, as needed, to the polymerization monomer; dissolving or dispersing the above constituents into the polymerization monomer by using, for example, a homogenizer, a sand mill, a sand grinder or an ultrasound dispersing machine; dispersing the polymerization monomer in which the above constituents are dissolved or dispersed in an aqueous medium containing a dispersion stabilizer as oil droplets of desired size as a toner, using such as a homomixer or a homogenizer; transferring the product into a reactor equipped with a stirring mechanism having a stirring wing which will be described later; heating the product to proceed the polymerization reaction; removing the dispersion stabilizer after the polymerizion reaction is over; filtering; washing; and drying.

A method for preparing the toner may include one in which resin particles are associated, or fused, in an aqueous medium, for example, methods described in JP-A Nos. 5-265252, 6-329947, and 9-15904 are listed, although the method is not specifically limited. Namely, a toner may be manufactured by employing a method in which dispersed particles of components such as resin particles and colorant particles, or a plurality of particles containing such as a resin and a colorant are associated, specifically, a toner may be manufactured in such a manner that, after dispersing these particles in water employing an emulsifying agent, the resultant dispersion is salted out by adding a coagulant with a concentration of more than the critical coagulating concentration, and simultaneously the formed polymer itself is heat-fused at a temperature higher than the glass transition temperature of the polymer to gradually grow the particle diameter, and, when the particle diameter reaches the desired value, particle growth is stopped by adding a relatively large amount of water, the resultant particle surface is smoothed by being further heated and stirred to control the shape, and the resultant particles which incorporate water, is again heated and dried in a fluid state. Further, herein, organic solvents, which are infinitely soluble in water, may be simultaneously added together with the coagulant.

Herein, detailed descriptions are made in JP-A No. 2000-214629 with respect to materials and a production method to produce a toner exhibiting uniform shape coefficient preferably used in the present invention, as well as a reaction apparatus for a polymerized toner.

A charging roller may be used instead of the charging brush shown in FIG. 1 or 2. FIG. 3 is a cross-sectional view showing the constitution of a charging roller.

As shown in FIG. 3, charging roller 22R described above is composed of core metal 22a and rubber layer or sponge layer 22b of chloroprene rubber, urethane rubber, or silicone rubber as a conductive elastic member arranged on the outer circumference of the core metal, and is structured by proving, as the outmost layer, protective layer 22c made of a releasable fluorine resin or silicone resin layer of a thickness of 0.01-1 μm.

The charging roller is preferably brought into pressure contact with above photoreceptor 21 at a pressure contact force of 10-100 g/cm. Further, the charging roller preferably rotates 1-8 times as fast as the peripheral rate of photoreceptor 21.

Herein, the above image forming apparatus represents a black and white laser printer based on a contact charging method. The same effects are produced with respect to a laser printer based on a non-contact method employed as the charging method. Further, the same application is possible for a color laser printer and copier. As for an exposure source, for example, an LED light source may also be used as a light source other than a laser beam.

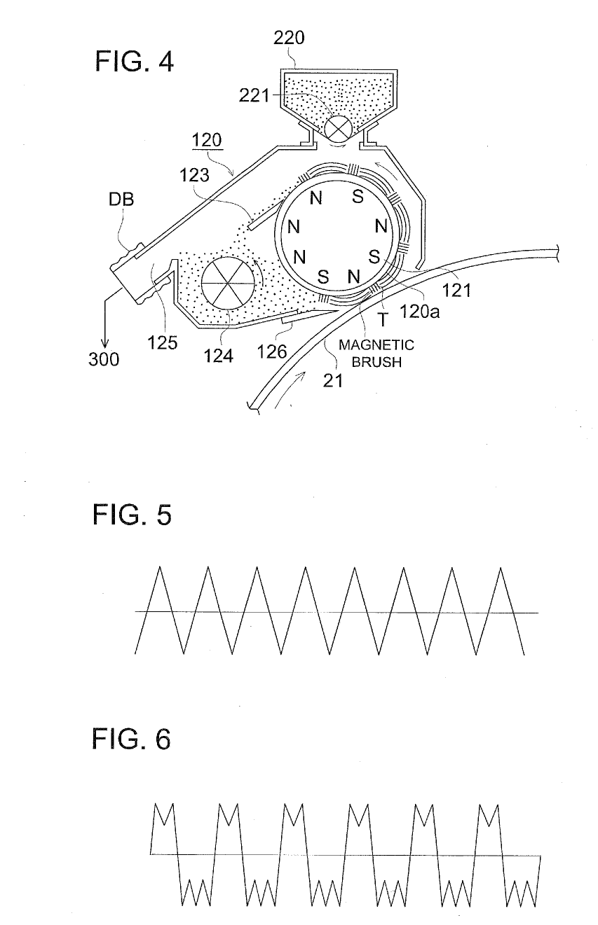

Further, instead of the charging brush in FIG. 1 or 2 described above, a magnetic brush charging unit may be used. FIG. 4 is a view showing one cross-sectional example of the magnetic brush charging unit.

In FIG. 4, 120 represents a magnetic brush charging unit; 21 represents a photoreceptor drum; T represents a charging section, 120a represents a charging sleeve; 121 represents a magnetic body; 123 represents a scraper; and 124 represents a stirring screw.

According to FIG. 4, magnetic brush charging unit 120 serving as a charging unit faces rotating photoreceptor drum 21 and incorporates cylindrical charging sleeve 120a made of, for example, an aluminum or stainless steel material serving as a charging magnetic particle conveying body allowed to rotate in the same direction (counter-clockwise) at the vicinity portion (charging section T) to photoreceptor drum 21; magnetic body 121 having N and S poles provided in above charging sleeve 120a; a magnetic brush composed of magnetic particles formed on the outer circumference of charging sleeve 120a by above magnetic body 121 to charge photoreceptor drum 21, scraper 123 to scrape the magnetic brush on above charging sleeve 120a at the N-N magnetic pole portion of magnetic body 121; stirring screw 124 to stir magnetic particles in magnetic brush charging unit 120 or to discharge used magnetic particles via overflowing from discharge outlet 125 of magnetic brush charging unit 120 during magnetic particle feeding; and earring regulation plate 126 for the magnetic brush. Charging sleeve 120a is rotatable with respect to magnetic body 121 and is preferably allowed to rotate at a peripheral rate of 0.1-1.0 time of that of photoreceptor drum 21 at the opposed position to photoreceptor drum 21 in the same direction (counter-clockwise) as the moving direction of the same. Further, for charging sleeve 120a, a conductive conveying carrier enabling to apply a charging bias voltage is used. However, there are specifically preferably used those having a structure wherein in the interior of conductive charging sleeve 120a on the surface of which a particle layer is formed, magnetic body 121 having a plurality of magnetic poles are arranged. In such a conveying carrier, via relative rotation to magnetic body 121, a magnetic particle layer formed on the surface of conductive charging sleeve 120a moves in a wavelike undulating manner, whereby fresh magnetic particles are fed continuously. Therefore, even when a magnetic particle layer on the surface of charging sleeve 120a exhibits layer thickness non-uniformity to some extent, the resulting adverse effects are sufficiently reduced to be practically unproblematic by the above wavelike undulations. The surface average roughness of the surface of charging sleeve 120a is preferably allowed to be 5.0-30 μm to carry out stable uniform conveyance of magnetic particles. Smoothness results in insufficient conveyance, and excessive roughness results in overcurrent flowing from convex portions of the surface. In either case, charging non-uniformity tends to be generated. To realize the above surface roughness, sandblasting treatment is preferably used. Further, the outer diameter of charging sleeve 120a is preferably 5.0-20 mm. Thereby, a contact area needed for charging is ensured. When the contact area is larger than necessary, charging current becomes excessively large. In the case of being small, charging non-uniformity tends to be generated. Further, in the case of a relatively small diameter as described above, magnetic particles are likely to fly or adhere to photoreceptor drum 21 by centrifugal force. Accordingly, the linear velocity of charging sleeve 120a is preferably almost the same as the moving velocity of photoreceptor drum 21 or smaller than that.

Further, the thickness of a magnetic particle layer formed on charging sleeve 120a is preferably a thickness which realizes a uniform layer via enough scraping by a regulation member. When the existing amount of magnetic particles on the surface of charging sleeve 120a in a charging area is excessively large, the magnetic particles are insufficiently vibrated, whereby friction and charging non-uniformity of the photoreceptor tends to occur and also overcurrent is likely to flow, resulting in the disadvantage that the driving torque of charging sleeve 120a increases. In contrast, when the existing amount of magnetic particles on charging sleeve 120a in the charging area is excessively small, portions being in imperfect contact with photoreceptor drum 21 are generated, whereby adhesion and charging non-uniformity of the magnetic particles on photoreceptor drum 21 results. Accordingly, a series of experiments have been conducted. And thereby, it becomes clear that the adhesion amount of magnetic particles in a charging area is preferably 100-400 mg/cm², specifically preferably 200-300 mg/cm². Herein, this adhesion amount is the average value in the charging area of a magnetic brush.

The image forming method and the image forming apparatus of the present invention are applied to common electrophotographic apparatuses such as electrophotographic copiers, laser printers, LED printers, or liquid crystal shutter-type printers. In addition, it is possible to find wide applications in display, recording, short-run printing, plate making, and apparatuses such as facsimile machines to which electrophotographic technology is applied.

### EXAMPLES

Next, the constitution and the effects of the present invention will now further be described with reference to a representative embodiment of the present invention.

Herein, “part” referred to in the following sentences represents “part by mass” and also “%” represents “% by mass” unless otherwise specified.

### Production of Photoreceptor 1

### Support 1

In cut processing of a cylindrical aluminum support, a diamond-sintered flat bite which forms a complex corrugation processed pattern was used. After the mounting angle and the indentation depth of the bite were adjusted, using a washing liquid prepared via 10-fold dilution of washing liquid BE-CLEAR CW5524 (produced by Dai-ichi Kogyo Seiyaku Co., Ltd.), high pressure jetting treatment was carried out at a jetting pressure of 3.92 MPa to allow the skewness (Rsk) of a cross sectional curve and ten-point surface roughness Rz of the support surface to be −0.24 and 1.3 μm, respectively.

### Intermediate Layer 1

An intermediate layer coating liquid described below was coated on the above support via an immersion coating method to form intermediate layer 1 of a dry film thickness of 5.0 μm. The following intermediate layer dispersion was two-fold diluted with the same mixed solvent and allowed to stand overnight, followed by filtration (filter: RIGIMESH filter of a nominal filtration accuracy of 5 μm; pressure: 50 kPa, produced by Nihon Pall Ltd.) to prepare an intermediate layer coating liquid.

(Production of an Intermediate Layer Dispersion)

Binder resin: (exemplified polyamide N-1) 1 part

Anatase-type titanium oxide A1 (primary particle diameter: 30 nm; surface treatment: ethyltrimethoxysilane fluoride treatment) 3.0 parts

Isopropyl alcohol 10 parts

The above components were mixed and dispersed for 10 hours using a sand mill homogenizer in a batch manner to produce an intermediate layer dispersion.

### Charge Generating Layer

The following components were mixed and dispersed using a sand mill homogenizer to prepare a charge generating layer coating liquid. This coating liquid was coated via an immersion coating method on the intermediate layer and a charge generating layer of a dry film thickness of 0.8 μm was formed.

| | |
|---|---|
| Y-type oxytitanylphthalocyanine (the maximum peak angle | 20 parts |
| is 27.3 in terms of 2θ in the X-ray diffraction spectrum | |
| based on Cu—Kα radiation) | |
| Polyvinyl butyral (#6000-C, produced by Denki Kagaku | 10 parts |
| Kogyo KK) | |
| t-Butyl acetate | 700 parts |
| 4-Methoxy-4-methyl-2-pentanone | 300 parts |

### Charge Transporting Layer

The following components were mixed and dissolved to prepare a charge transporting layer coating liquid. This coating liquid was coated on the above charge generating layer via an immersion coating method and a charge transporting layer of a dry film thickness of 24 μm was formed. Thus, photoreceptor 1 was produced.

| | | |
|---|---|---|
| Charge transporting material (4-methoxy-4′-(4-methyl-α- | 75 | parts |
| phenylstyryl)triphenylamine) | | |
| Polycarbonate resin “LUPILON Z300” (produced by | 100 | parts |
| Mitsubishi Gas Chemical Company, Inc.) | | |
| Antioxidant (following compound AO-1) | 2 | parts |
| Tetrahydrofuran/toluene (volume ratio: 7/3) | 750 | parts |

N-1

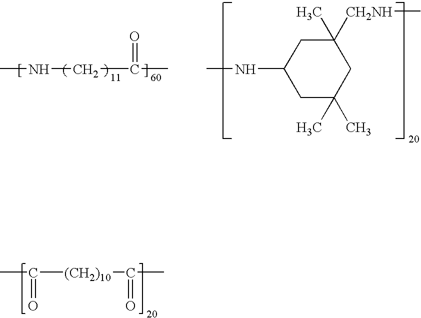

AO-1

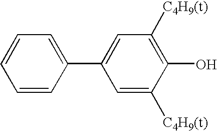

### Production of Photoreceptors 2-12

Photoreceptors 2-12 were produced in the same manner as for photoreceptor 1 except that the cutting conditions (the bite angel and the indentation depth) of the aluminum support and dry ice or sand jetting pressure were appropriately changed to change Rsk and Rz as shown in Table 1; and the titanium oxide and the film thickness of the intermediate layer were also changed as shown in Table 1.

### Photoreceptor 2

Photoreceptor 2 was produced in the same manner as for photoreceptor 1 except that instead of the high pressure jetting treatment for the support of photoreceptor 1, dry ice blasting was carried out with dry ice particles of 0.3 mm at a jetting pressure of 0.4 MPa using super blast DSC-1 (produced by Fuji Manufacturing Co., Ltd.); and the film thickness of the intermediate layer was changed to 6 μm.

### Photoreceptor 3

The same method was used as for photoreceptor 2 except that dry ice particles of 1 mm in diameter and a jetting pressure of 0.6 Mpa were employed.

### Photoreceptor 4

The same method was used as for photoreceptor 1 except that instead of the high pressure jetting treatment for the support of photoreceptor 1, micro-sandblasting was carried out with alumina (Al₂O₃) #5000 (average particle diameter: 2 μm) as abrasive particles at a blasting pressure of 3 kg/cm² using MICROBLASTER MB1 (produced by Sintobrator, Ltd.).

### Photoreceptor 5

The same method was used as for photoreceptor 4 except that alumina (Al₂O₃) #3000 (average particle diameter: 5 μm) as abrasive particles was blasted at a blasting pressure of 5.5 kg/cm²; and the film thickness of the intermediate layer was changed to 8 μm.

### Photoreceptor 6

Photoreceptor 6 was produced in the same manner as for photoreceptor 1 except that in photoreceptor 1, the cutting processing conditions were changed (the bite angle and the indentation depth were also changed using a diamond-sintered R bite forming a simple corrugation pattern) to change the skewness (Rsk) of a cross sectional curve and ten-point average roughness Rz as shown in Table 1; the titanium oxide of the intermediate layer was changed to rutile-type titanium oxide A2 of a primary average particle diameter of 25 nm (surface-treated similarly to A1); and the film thickness thereof was changed to 3 μm.

### Photoreceptor 7

Photoreceptor 7 was produced in the same manner as for photoreceptor 4 except that the cut processing conditions were changed (the bite angle and the indentation depth were also changed using a diamond-sintered R bite forming a simple corrugation pattern) to change the skewness (Rsk) of a cross sectional curve and ten-point average roughness Rz as shown in Table 1; the titanium oxide of the intermediate layer was changed to rutile-type titanium oxide A3 of a primary average particle diameter of 35 nm (surface-treated similarly to A1); and the film thickness thereof was changed to 2 μm.

### Photoreceptor 8

Photoreceptor 8 was produced in the same manner as for photoreceptor 1 except that anatase-type titanium oxide A1 in the intermediate layer was changed to rutile-type titanium oxide A4 (primary average particle diameter: 15 nm; surface-treated with methylhydrogensiloxane) and the film thickness thereof was changed to 3 μm.

### Photoreceptor 9

Photoreceptor 9 was produced in the same manner as for photoreceptor 4 except that anatase-type titanium oxide A1 in the intermediate layer was changed to zinc oxide (primary average particle diameter: 15 nm; surface-treated with methylhydrogensiloxane).

### Photoreceptor 10

Photoreceptor 10 was produced in the same manner as for photoreceptor 4 except that anatase-type titanium oxide A1 in the intermediate layer was changed to brookite-type titanium oxide A5 (primary average particle diameter: 75 nm; surface-treated with methylhydrogensiloxane).

### Photoreceptor 11 (Comparative Example)

Photoreceptor 11 was produced in the same manner as for photoreceptor 1 except that no high pressure jetting washing was conducted.

### Photoreceptor 12 (Comparative Example)

Photoreceptor 12 was produced in the same manner as for photoreceptor 4 except that blasting was carried out at a blasting pressure of 1 kg/cm².

### (Evaluation 1)

Each of the thus obtained photoreceptors was basically mounted in EPSON LP-2400 (a printer having an A4 paper output capability of up to 16 sheets/minute employing a contact charging method by a charging brush and a cleanerless process, marketed by Epson Sales Japan Corp.) having the constitution described in FIG. 2. Then, durability was tested at low temperature and low humidity (LL: 10° C. and 20% RH) (herein, dielectric breakdown was evaluated also under a condition of high temperature and high humidity (HH: 30° C. and 80% RH)). Specifically, an image sample quartered by a character image of a pixel ratio of 7%, a halftone image, a solid white image, and a solid black image was printed on 20000 sheets in total. Evaluation was conducted at the initial stage and after 20000 sheets printing. Evaluation items and evaluation criteria are described below. The evaluation results are shown in Table 1.

### Exposure Conditions

Exposed portion potential target: The exposure amount was set to be less than −50 V.
Exposure beam: An image exposure was carried out at a dot density of 600 dpi (“dpi” refers to the number of dots per 2.54 cm). As a laser, a semiconductor laser of 780 nm was used.

Developing conditions: Reverse development was conducted employing a non-magnetic single component developer (a non-magnetic single-component developer of a weight average particle diameter of 6.3 μm containing hydrophobic titanium oxide of 0.3 μm and hydrophobic silica of 15 nm as additives).

### <Image Density>

Measurement was carried out using RD-918 (produced by Macbeth Co.). Relative reflection density was measured provided that the reflection density of paper was designated as “0.” When the residual potential is increased via copying of a large number of sheets, image density is decreased.

A: The solid black image has a density of more than 1.2 (excellent).

B: The solid black image has a density of 1.0-1.2 (practically acceptable).

C: The solid black image has a density of less than 1.0 (practically problematic).

### <Fog>

Fog density was determined by the reflection density of the solid white image using RD-918 (produced by Macbeth Co.). This reflection density was evaluated based on a relative density (the density of unprinted A4 paper was designated as 0.000).

A: Density is less than 0.010 (excellent).

B: Density is 0.010-0.020 (practically acceptable).

C: Density is more than 0.020 (practically problematic).

### <Black Spots>

Determination was conducted based on the number of visible black spot or black line image defects per A4 size whose periodicity corresponded to the period of the photoreceptor.

A: Frequency of image defects of at least 0.4 mm: at most 5 defects/A4 with respect to all the printed images (excellent)

B: Frequency of image defects of at least 0.4 mm: occurrence of at least one sheet with a frequency of 6 defects/A4-10 defects/A4 (practically unproblematic)

C: Frequency of image defects of at least 0.4 mm: occurrence of at least one sheet with at least 11 defects/A4 (practically problematic)

### <Dielectric Breakdown>

Evaluation was conducted at low temperature and low humidity (LL: 10° C. and 20% RH) and at high temperature and high humidity (HH: 30° C. and 80% RH).

A: No dielectric breakdown of a photoreceptor due to charge leakage occurs at LL or HH.

B: Dielectric breakdown of a photoreceptor due to charge leakage occurs at LL or HH.

### <Interference Fringes>

The halftone image was printed to confirm the occurrence level of interference fringes.

A: Interference fringes: no occurrence which is excellent.

B: Interference fringes: partial occurrence which is practically acceptable.

C: Interference fringes: Occurrence over the entire image which is practically problematic.

TABLE 1

| | Conductive | | Intermediate Layer | | | | | | | | |
|---|---|---|---|---|---|---|---|---|---|---|---|
| Photo- | Support | | | Particle | Film | | | | | | |
| receptor | | Rz | Particle | Diameter | Thickness | Image | | Dielectric | Black | Interference | |
| No. | Rsk | (μm) | Species | (nm) | (μm) | Density | Fog | Breakdown | Spots | Fringes | Remarks |
| 1 | −0.24 | 1.3 | A1 | 30 | 5 | A | B | A | A | A | Inv. |
| 2 | −1.36 | 1.1 | A1 | 30 | 6 | A | A | A | A | A | Inv. |
| 3 | −3.21 | 1.0 | A1 | 30 | 6 | A | A | A | A | A | Inv. |
| 4 | −7.84 | 0.8 | A1 | 30 | 5 | A | A | A | B | B | Inv. |
| 5 | −9.78 | 0.7 | A1 | 30 | 8 | A | A | A | B | C | Comp. |
| 6 | −0.38 | 0.3 | A2 | 25 | 3 | B | B | A | A | B | Inv. |
| 7 | −0.74 | 2.3 | A3 | 35 | 2 | B | B | A | A | A | Inv. |
| 8 | −0.24 | 1.3 | A4 | 15 | 3 | B | B | A | A | A | Inv. |
| 9 | −7.84 | 0.8 | Z | 155 | 5 | B | A | A | B | B | Inv. |
| 10 | −7.84 | 0.8 | A5 | 75 | 5 | B | A | A | B | B | Inv. |
| 11 | 1.42 | 1.3 | A1 | 30 | 5 | B | B | B | B | A | Comp. |
| 12 | 0.18 | 1.3 | A1 | 30 | 5 | B | B | B | B | A | Comp. |

Inv.: inventive,
Comp.: comparative

In Table 1, A1 represents anatase-type titanium oxide; A2, A3, and A4 represent rutile-type titanium oxide; A5 represents brookite-type titanium oxide; and Z represents zinc oxide.

Table 1 shows that photoreceptors 1-4 and 6-10, of which the skewness (Rsk) of the cross sectional curve of each of the conductive support surface thereof fell within the range of the present invention, exhibited the excellent results with respect to each of the evaluation items; however, in contrast, each of photoreceptors 5, 11, and 12, of which the skewness (Rsk) of the cross sectional curve of each of the comparative conductive support surface thereof was out of the range of the present invention, was evaluated to be insufficient at least one of the evaluation items.

### (Evaluation 2)

The charging brush of the evaluation machine in evaluation 1 was replaced with a charging roller and then photoreceptors 1-12 were evaluated. The evaluation results of each of the photoreceptors were almost the same as in evaluation 1.

What is claimed is:

1. An organic photoreceptor comprising a conductive support having thereon at least an intermediate layer and a photosensitive layer, wherein
a skewness Rsk of a cross sectional curve of a surface of the conductive support meets the condition of −8<Rsk<0.

2. The organic photoreceptor of claim 1, wherein
the cross sectional curve has a regular corrugation processed shape.

3. The organic photoreceptor of claim 1, wherein
the cross sectional curve has a cut processed shape.

4. The organic photoreceptor of claim 1, wherein
the intermediate layer comprises a N-type semiconductor particle.

5. The organic photoreceptor of claim 4, wherein
the N-type semiconductor particle is a titanium oxide particle or a zinc oxide particle.

6. A method of forming an image comprising the steps of:
charging a surface of an organic photoreceptor;
exposing the charged organic photoreceptor to form an electrostatic latent image;
developing the electrostatic latent image formed on the organic photoreceptor using a toner to form a toner image; and
transferring the toner image formed on the organic photoreceptor onto a transfer medium,
wherein
charging is carried out via a contact charging method; and
the organic photoreceptor is the organic photoreceptor of claim 1.

7. An image forming apparatus forming an electrophotographic image employing the method of claim 6.

8. An image forming unit having an image forming member, the image forming unit being capable of being loaded into or unloaded from an image forming apparatus, and the image forming unit comprising:
a charging means charging a surface of an organic photoreceptor;
an exposing means exposing the charged organic photoreceptor to form an electrostatic latent image;
a developing means developing the electrostatic latent image formed on the organic photoreceptor using a toner to form a toner image; and
a transfer means transferring the toner image formed on the organic photoreceptor onto a transfer medium
wherein
charging is carried out via a contact charging method; and
the organic photoreceptor is the organic photoreceptor of claim 1.

9. The organic photoreceptor of claim 2, wherein the conductive support is a cylindrical conductive support.

10. The organic photoreceptor of claim 3, wherein the conductive support is a cylindrical conductive support.

11. A method of forming an image comprising the steps of:
charging a surface of an organic photoreceptor;
exposing the charged organic photoreceptor to form an electrostatic latent image;
developing the electrostatic latent image formed on the organic photoreceptor using a toner to form a toner image; and
transferring the toner image formed on the organic photoreceptor onto a transfer medium,
wherein
charging is carried out via a contact charging method; and
the organic photoreceptor is an organic photoreceptor comprising a conductive support having thereon at least an intermediate layer and a photosensitive layer,
wherein
a skewness Rsk of a cross sectional curve of a surface of the conductive support meets the condition of −8<Rsk<0.

12. An image forming unit having an image forming member, the image forming unit being capable of being loaded into or unloaded from an image forming apparatus, and the image forming unit comprising:
a charging means charging a surface of an organic photoreceptor;
an exposing means exposing the charged organic photoreceptor to form an electrostatic latent image;
a developing means developing the electrostatic latent image formed on the organic photoreceptor using a toner to form a toner image; and
a transfer means transferring the toner image formed on the organic photoreceptor onto a transfer medium,
wherein
charging is carried out via a contact charging method; and
the organic photoreceptor is an organic photoreceptor comprising a conductive support having thereon at least an intermediate layer and a photosensitive layer,
wherein
a skewness Rsk of a cross sectional curve of a surface of the conductive support meets the condition of −8<Rsk<0.
